(19) United States
(12) Patent Application Publication
(10) Pub. No.: US 2015/0200562 A1
(43) Pub. Date: Jul. 16, 2015

(54) INTELLIGENT REMOTE POWERING

(71) Applicant: ECOLE POLYTECHNIQUE FEDERALE DE LAUSANNE (EPFL), Lausanne (CH)

(72) Inventors: Enver Kilinc, Lausanne (CH); Catherine Dehollain, Romanel-sur-Morges (CH)

(21) Appl. No.: 14/421,374

(22) PCT Filed: Aug. 13, 2013
(86) PCT No.: PCT/IB2013/056611

§ 371 Date: Feb. 12, 2015

(30) Foreign Application Priority Data
Aug. 17, 2012 (EP) 12180919.8

(51) Int. Cl. H02J 7/02; H04B 5/00

(52) U.S. Cl. CPC H02J 7/025; H04B 5/0037

(57) ABSTRACT

A telemetric device with electronics comprises at least one of a sensor, an actuator or a data transmission device; at least one super-capacitor arranged as a power storage and a supply voltage for the at least one of a sensor, an actuator or a data transmission device; and an intelligent charging electronic circuit configured to charge the super-capacitor to a predetermined voltage level.

### TECHNICAL FIELD

The present invention relates to wireless power transmission for freely moving tags, more particularly for implanted devices.

### BACKGROUND

Wireless power transmission becomes more popular due to the advance in microelectronics. The power consumption of the electronic circuits decreases hence it allows wireless power transmission to become more common. There are many wireless power transmission methods [1-8]. One of the most popular and efficient methods is remote powering by using a magnetically coupled link. The magnetically coupled link is more efficient if the distance between the antennas (coils) is relatively little, i.e., in a range of mm to few dm, and more power is required by a receiving side antenna, e.g. in a tag or an implant [1-3].

Power transmission efficiency is maximized when the two antennas (coils) are concentralized. The power transmission efficiency reduces drastically when e.g. the implanted coil moves away from the center of the powering coil. For the applications where the tag or implanted device which is moving freely in an environment or space, it is very difficult to transfer power continuously. Therefore, the proposed ideas in the invention solve the continuous power transmission problem for the freely moving object which has implanted device inside. Especially, the idea is valid for the biomedical applications such as animal research in the laboratory.

This means that the energy should be stored somewhere when continuous power is needed in order not to shut down the implanted system and guarantee continuous measurement, activation and/or monitoring etc. On the other hand, some intelligent mechanism can handle the tracking of the implanted device and deliver sufficient power to the system. Furthermore, the combination of the intelligent mechanism and the energy storage enables multiple remote powering systems at the same time as proposed in the document.

### SUMMARY OF THE INVENTION

In a first aspect the invention provides a telemetric device with electronics comprising at least one of a sensor, an actuator or a data transmission device; at least one super-capacitor arranged as a power storage and a supply voltage for the at least one of a sensor, an actuator or a data transmission device; and an intelligent charging electronic circuit configured to charge the super-capacitor to a predetermined voltage level.

In a preferred embodiment the intelligent charging electronic circuit comprises a power on reset circuit configured to prevent current from flowing through the intelligent charging electronic circuit when the supply voltage is insufficient for the at least one of a sensor, an actuator or a data transmission device.

In a second aspect the invention provides an implantable device for use in a freely moving object, comprising the telemetric device.

In a third aspect the invention provides a system comprising the implantable device, and further comprising tracking means distinct from the implantable device and configured to track a movement of the implanted device, and an intelligent remote powering mechanism distinct from the implantable device and arranged to provide power to the super-capacitor. The intelligent remote power mechanism comprises a power source; and actuating means configured to move the power source according to the movement of the implanted device.

In a preferred embodiment the system further comprises at least an additional implantable device according to claim 3, and for each additional implantable device a corresponding additional tracking means, and a corresponding additional intelligent remote powering system.

In a preferred embodiment of the system, the power source is one of the list comprising a powering coil, an antenna, and a transducer.

In a preferred embodiment of the system the intelligent remote powering system is extended for multiple freely moving objects using a combination of the telemetric device and the implantable device as described herein above.

In a preferred embodiment the system further comprises one of a rechargeable battery and a supercapacitor, further comprising detection means arranged to detect a proximity of the implanted device and trigger the charge of the implantable device.

In a preferred embodiment of the system, the implantable device is a remotely powered capsule for biomedical application.

### BRIEF DESCRIPTION OF THE FIGURES

The invention will be better understood in view of the description of preferred embodiments and in reference to the figures, wherein:

FIG. 1 illustrates the external module including (1) Remote powering unit has powering coil and power amplifier in order to transfer the power transfer, (2) Transceiver receives data which is sent by internal module, (3) A host machine which process the received data and displays the result in a graphical user interface. Also, it demonstrates internal module inside the animal;

FIG. 2 is the internal module including (a) Implant coil, rectifier, supercapacitor and voltage regulator create a supply for sensor system; (b) Intelligent charging electronic circuit such as Power on reset (PoR) is used to control available voltage level; (c) Transmitter (TX) is employed for data transfer from implanted sensor unit to external module;

FIG. 3 illustrates PoR circuit for creating a hysteresis in supply voltage (Vcharge and Vdischarge); (d) PoR circuit and supercapacitor can be used not only for electromagnetic radiation but also the other energy harvesting and power transfer methods such as vibration, ultrasound, thermal;

FIG. 4 shows the intelligent remote powering system for animal research applications which can track the freely moving animal and move the powering coil in order to transfer continuous power for the implanted device;

FIG. 5 illustrates the mechanism of the movement of the powering coil for the animal research application;

FIG. 6 shows the simplified flowchart of the iRPower system algorithm;

FIG. 7 shows the building blocks of the hardware of iRPower system;

FIG. 8 shows the proof of concept of iRPower system for freely moving animal;

FIG. 9 demonstrates possible application for multiple animal measurement environment;

FIG. 10 shows an application for mobile charging for automobiles;

FIG. 11 demonstrates a miniaturization for smart houses; and

FIG. 12 illustrates an implant unit designed for minimum space consumption. Therefore, a flexible printed circuit board (PCB) is used and the implantable unit is folded in stages to squeeze in a cubic package.

### DESCRIPTION OF PREFERRED EMBODIMENTS OF THE INVENTION

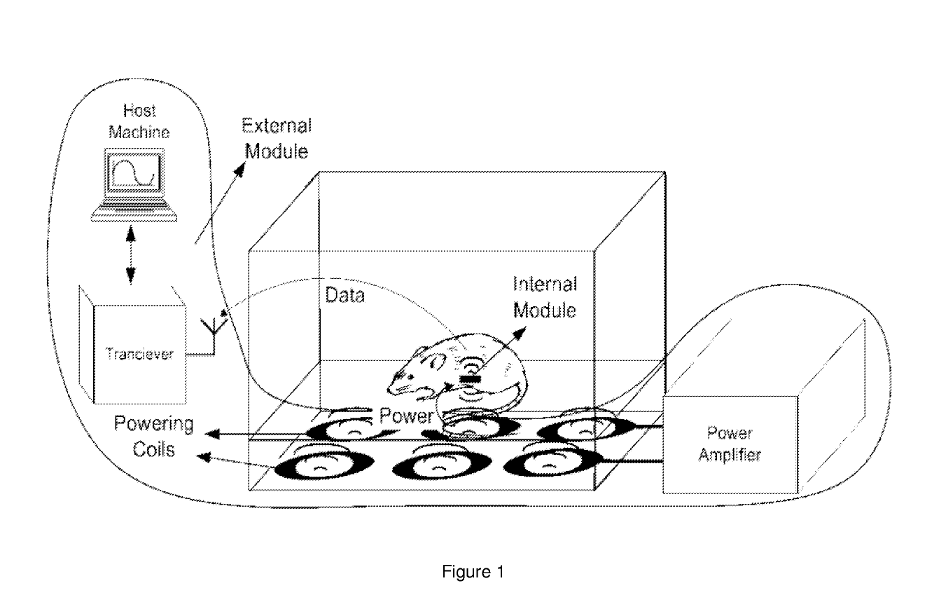

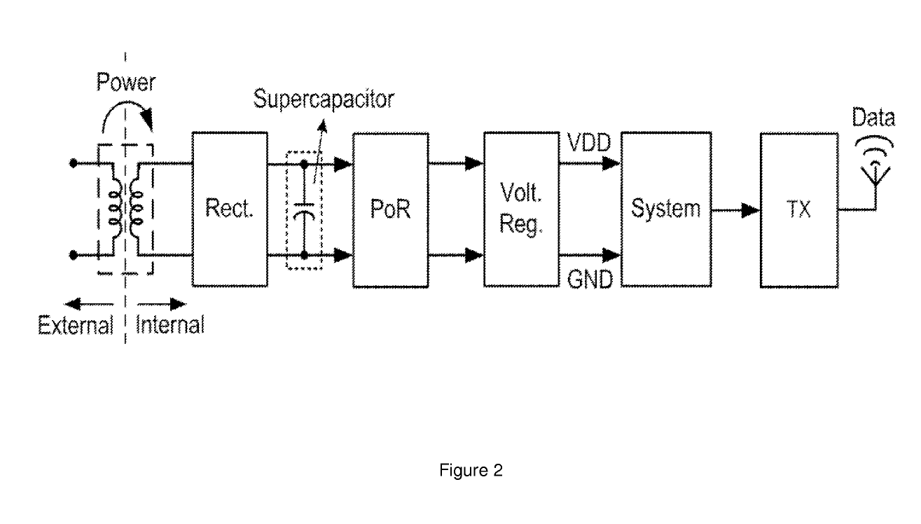

The invention provides an electronic system, an example embodiment of which comprises two modules that are presented in FIG. 1. The external module includes: (1) a remote powering unit with powering coils and power amplifier; (2) a transceiver for receiving data which is sent by internal module; and (3) a host machine which processes the received data and displays the result in a graphical user interface. The internal module which is represented in FIG. 2 includes: (a) a coil, rectifier, storage-element (supercapacitor), and voltage regulator which create a power supply for the sensor and/or actuator system; (b) an electronic circuit such as Power on Reset (PoR), used to control the available voltage level; and (c) a transmitter, employed for data transfer from the implanted sensor unit to the external module.

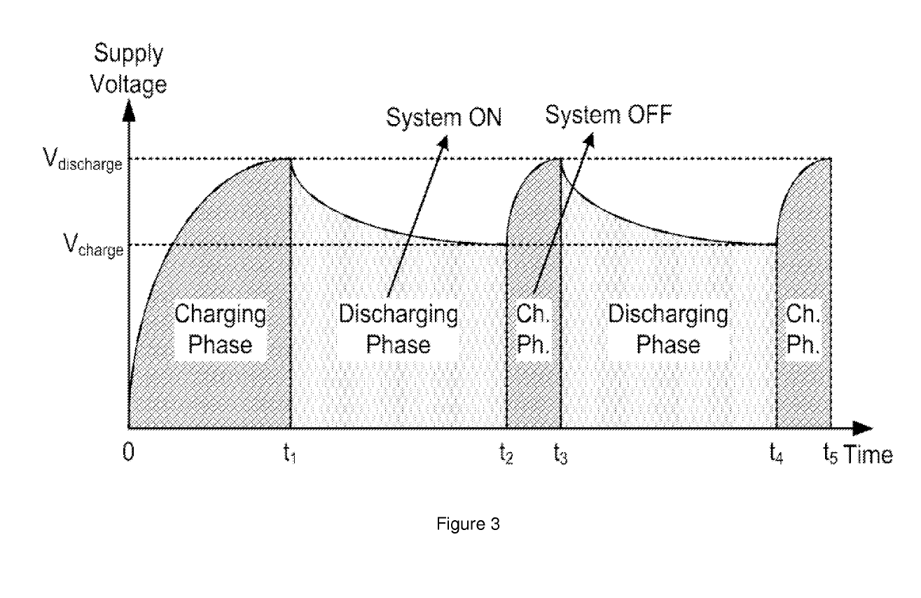

Among innovative parts of the electronic system are:
(a) a storage-element (supercapacitor): it is used instead of a battery in order to guarantee the continuous long-term measurements due to extreme number of charge/discharge cycle unlike battery which has only one discharge cycle and needs to be changed at the end of its lifetime. Also, the supercapacitor has large capacitance value, and a light weight compared to a battery;
(b) an intelligent charging electronic circuit such as a Power on Reset (PoR) circuit: it works as voltage level detector. The input of the circuit is tracked and a related output response is created. To simplify the circuit it works like a voltage controlled switch. If the input voltage is under a certain level, the circuit behaves like an open switch and doesn't allow current to pass hence the output voltage is zero. If the input voltage level exceeds the defined voltage (Vhigh), the PoR circuit lets current to pass and the output voltage is the same value as input voltage like a closed switch. On the other hand, if the voltage level is decreased under a defined value (Vlow), the PoR circuit blocks current and the output voltage becomes zero again due to the insufficient input voltage level;
(c) the same PoR circuit works as level controller and checks the level of the voltage (power available in the supercapacitor) such that it allows charging the supercapacitor up to a sufficient voltage level which is needed by the measurement circuits when a moving object, such as for example a rodent animal inside a cage, moves freely. In the addition it works like “wake up receiver” when the transmitted power is sufficient for the implanted device, it wakes up the whole system;
(d) in addition, the PoR circuit prevents the current flowing through the circuits when the supply voltage is insufficient for measurement and data transmission. In the electronic system, the transmitted power from the external module to the internal module is not always sufficient for measurement and/or activation of an actuator in implanted unit due to the freely moving object. Therefore, the PoR circuit is required for creating a hysteresis in supply voltage (Vcharge and Vdischarge) as demonstrated in FIG. 3. In FIG. 3, initially the power level (voltage level in the supercapacitor or input of the PoR circuit) is not sufficient for performing of the overall system. Hence, the PoR circuit checks and tracks the voltage level until it increases to Vdischarge level (maximum supply voltage level for the circuits without being damaged) which is defined by the overall system requirement. During this phase, the PoR circuit blocks the current to pass through in the rest of the circuits. Therefore, the supercacitor is charged to Vdischarged level quickly. After the supercapacitor is charged to the defined voltage level, the PoR circuit lets the current to pass through the rest of the circuits and the voltage level on the supercapacitor decreases down to Vcharge level (minimum supply voltage level needed by the circuits to sustain the operation) which is also defined by the system requirement. If the voltage level decreases to the Vcharge level, the PoR blocks current and starts the charging phase of the supercapacitor again. The charging and discharging phases continue in a hysteresis loop. This hysteresis loop is important for a moving object, such as for example a rodent animal inside a cage, moves freely. In such case, the powering coils are fixed but the object is moving freely or randomly. This means that the power transmission level is not fixed, the power transmission can be insufficient or even zero due to the position of the moving object reference to powering coils and the duration is not pre-defined or predictable and it is totally random due to the moving object (a rodent). Therefore the PoR circuit with hysteresis is required to charge a capacitor (supercapacitor or chargeable battery) in order to have a proper operation. When the power level is sufficient for delivery, the supercapacitor is charged by the PoR circuit. Even the power transmission has a discontinuity during the delivery, the PoR circuit conserves the voltage level on the supercapacitor by blocking current until it reaches Vdischarge level. When the voltage is at Vdischarge level which means that the supercapacitor is fully charged, the overall system starts to work until the voltage decreases to Vcharge level and the PoR circuit blocks current; and
(e) the PoR circuit and the supercapacitor can be used not only for electromagnetic radiation but also other energy harvesting and power transfer methods such as vibration, ultrasound, and thermal.

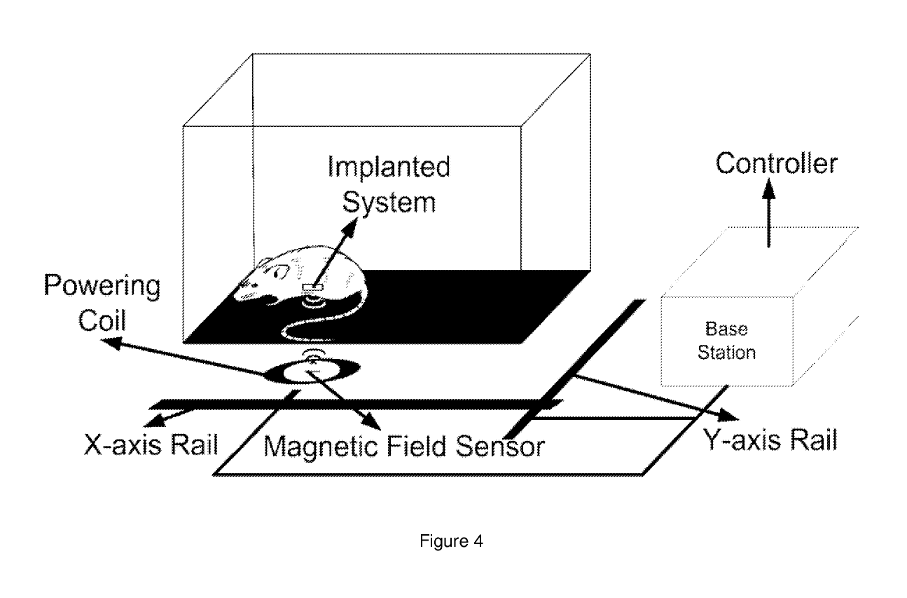

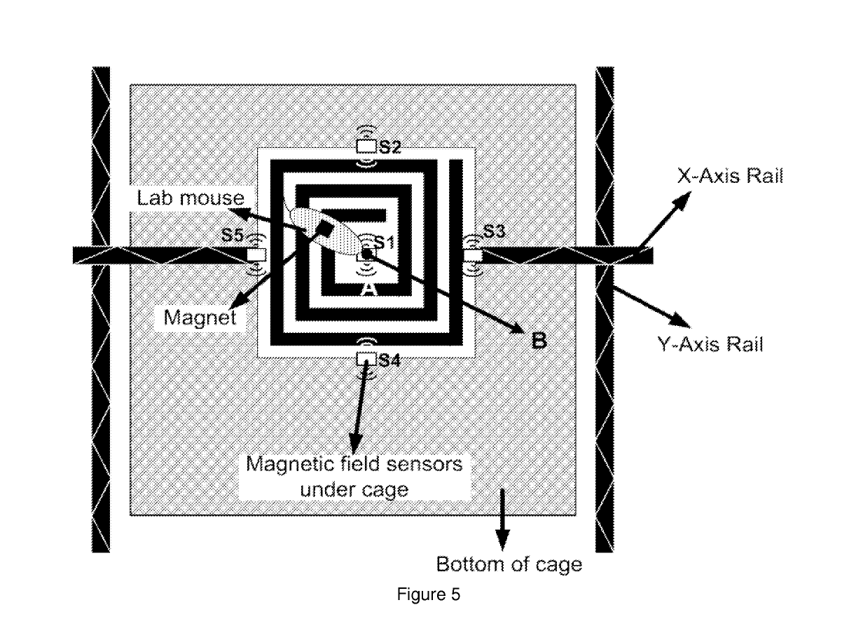

If the space is so critical for the implanted device (batteryless or capacitorless device), an intelligent remote powering (iRPower) is proposed in FIG. 4. There are two rails for tracking the implanted system which is inside a freely moving animal. An efficient continuous power transmission is always guaranteed due to moving ability in both axes (X and Y) of the powering coil. Therefore, the implanted system doesn't need any kind of battery or (super)capacitor. Additionally, thanks to controller (microcontroller and/or FPGA (memory)) blocks the freely moving animal is tracked and the movements are recorded. FIG. 5 illustrates the working principle of the system in detail. There are 4 magnetic field sensors at the sides (the number of the sensors can be increased for better detection) of the powering coil and one in the middle of the powering coil. A small magnet is placed in the implanted device. The output voltage of the magnetic field sensors changes due to the magnetic field applied by this magnet. If the magnet is close to the sensor, the sensor output voltage increases or decreases according to the closest pole of the magnet. The aim of the system is to track the magnet movement and to maximize the output voltage of the center sensor. For example, if the mouse moves from point A to point B as shown in FIG. 5, the output of the sensor 1 will decrease and that of sensor 3 and sensor 4 will increase. A controller system will check these sensors' output and control the X- and Y-axis rails according to the output of the sensors such that the implanted device and also the animal can be tracked and an efficient continuous power will be transferred.
a) Hence the idea can be applied to any kind of freely moving object which needs to be tracked and wherein a transfer of required power for the implanted or tag device is needed. The potential applications are in animal research in laboratories, and also in remotely powered endoscopic capsules for the human digestion examination.
b) In addition, it is possible to use a bed which has a motorized (X- and Y-axis) powering coil placed under it to produce a continuous remote powering system. The power can be used in a micro-capsule which makes examination and/or surgery in the body.
c) Also this tracking system can be extended for any kind of energy harvesting and power transfer methods such as ultrasound, light, etc. which have a power source and a movable target (tag, implant). The power source can track the target and demanded power by the target is delivered.

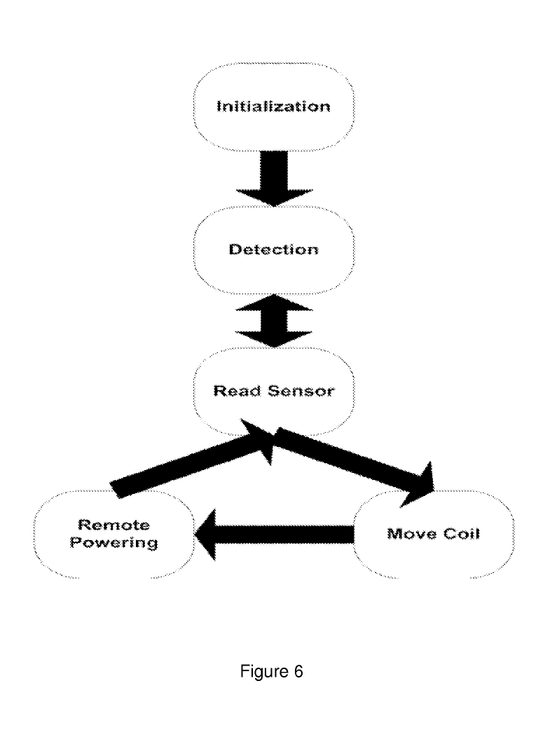

FIG. 6 shows the simplified flowchart of the iRPower system algorithm. iRPower system has 3 main phases: Initialization, Detection, and Read/Move/Power. In Initialization phase, iRPower system resets all the memories and brings the powering coil to the origin position (is important for monitoring moving object and can be defined by the user). In Detection phase, iRPower system starts to move the powering coil and magnetic field sensors to find the magnet and sweeps all the environment (cage) until one of the magnetic field sensor detects the magnet. When iRPower finds the magnet, the powering coil is placed to deliver power with maximum efficiency. In Read/Move/Power phase, it is a continuous loop to track moving object (animal) and transfer power. iRPower reads the outputs of the magnetic field sensor for change in the magnetic field. When the object moves, the sensors at the edges detect the change of the magnetic field. iRPower moves the powering coil according to the sensors outputs to maximize the power transmission efficiency. In other words, iRPower moves the powering coil until the magnetic sensor in the middle maximizes the output compared to the sensors at the edges. After the movement of the powering coil is finished and the powering coil is placed to efficient position to deliver power, the sensors are ready for detecting another movement of object. If iRPower loses the tracking of the moving object, the system automatically returns to Detection phase. If any reset is applied or iRPower is turned off and on again, iRPower returns to Initialization phase. In addition, in the proposed algorithm, all processes are processed sequentially. However, the processes can be operated in parallel by modifying the software and/or system controller (which has faster clock speed) in order to increase the overall speed of the iRPower system.

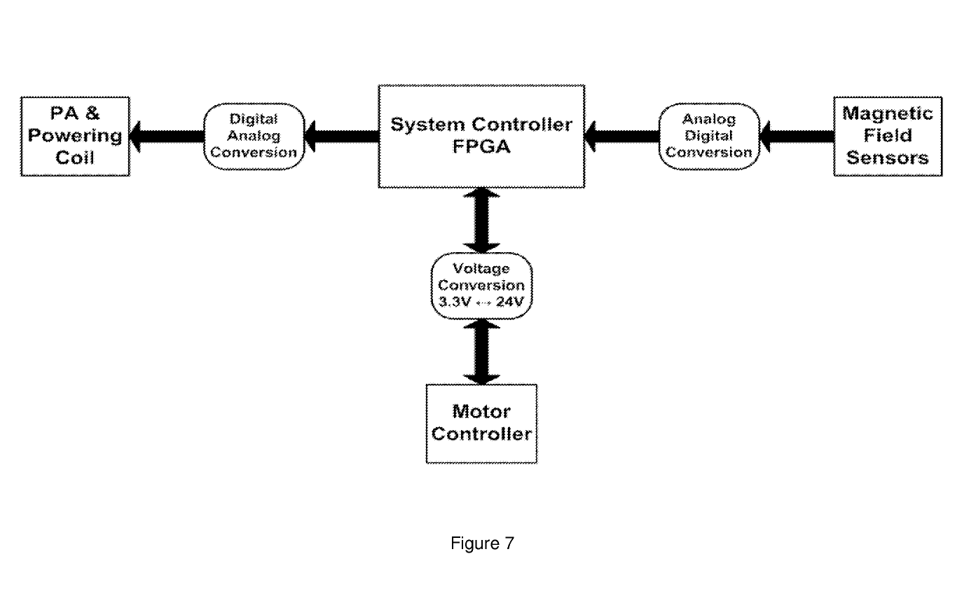

FIG. 7 shows the block diagram of the hardware of iRPower system. A system controller, a FPGA is used in this case, manages all the blocks and communicate with them. Magnetic field sensors which are used for detecting the magnet moves in the cage are connected to an auxiliary board. This board converts analog output of the sensors to digital bits (ADC) and enables the communication with FPGA. According to the information obtained from sensors, FPGA computes the next step of the movement of the X and Y rails (motors). The data is transmitted to the motor controllers. Before transmission the data needs to be adjusted due to high voltage requirement of the rails. Therefore, another auxiliary board is used between FPGA and motor controllers for adjustment of voltage and also communication (serial-to-parallel conversion). Motor controllers can also transmit some feedback information about the movement. The transferred power level can be adjusted by FPGA and increased during movement of X and/or Y rails to deliver sufficient power to implant for continuous operation at the implant module. Therefore, the supply commands are transmitted from FPGA to Power Amplifier (PA) to adjust the power level of the PA which is driving the powering coil. An auxiliary board is also needed to convert the digital bits to analog voltage (DAC) for PA supply voltage. Hence, the adjustable remote powering is obtained by tracking the moving animal or object.

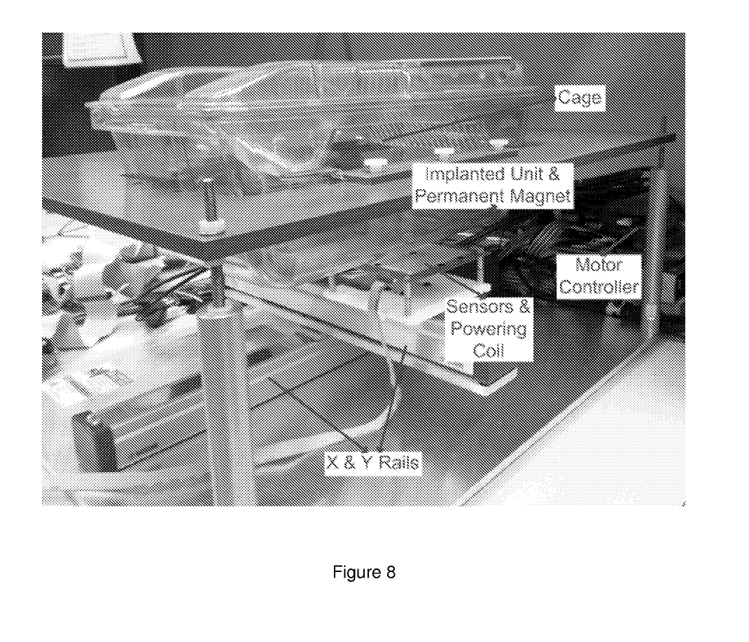

FIG. 8 illustrates the proof of concept of iRPower system for freely moving animal. The building blocks (X and Y rails, motor controllers, powering coil and magnetic field sensors, permanent magnet in the implant, and circuit boards) are shown in the figure. iRPower system proves that the system can manage to detect the moving object, deliver power and also monitor its moves.

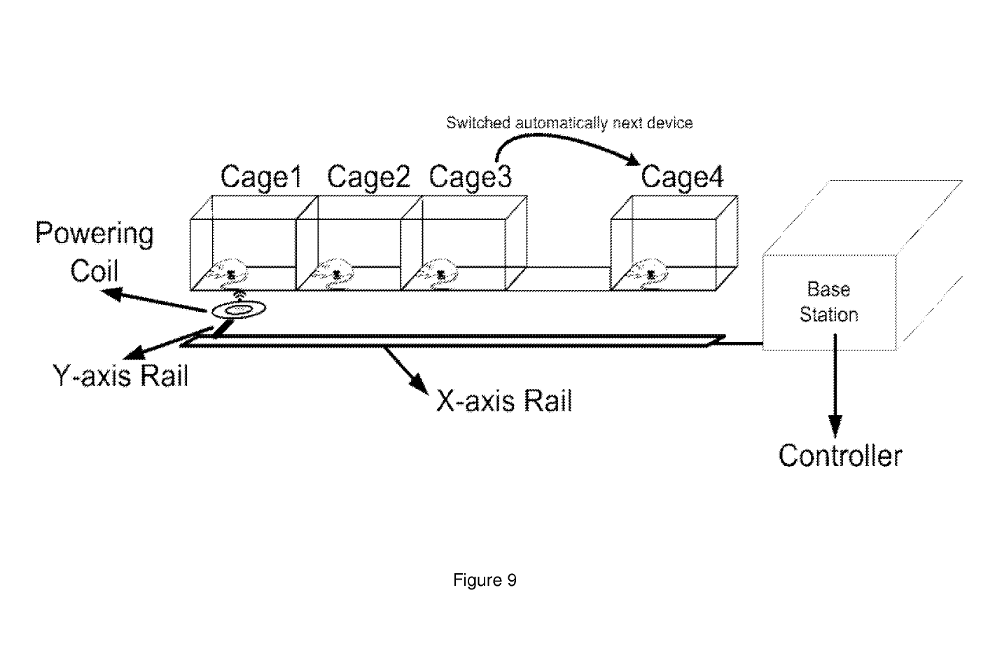

In animal laboratories, many animals are used as subjects in different or same research. In order to create a continuous remote powering for different animal, the intelligent charging system is proposed. If the implanted device has a (super)capacitor and/or chargeable battery and a PoR system, the implanted device is charged by the system as shown in FIG. 9. The motorized powering system (iRPower) will take care of the charging the implanted device one by one. If there is a missing of any cage (device) the system will automatically switch to the next device for charging. On the other hand, the system handles charging of the supercapacitor in an implanted device. The supercapacitor supplies the energy to the implanted device when the implanted device is not detectable at intervals. For instance, a swallowable capsule for biomedical application cannot be detectable always due to the distance. Therefore, the motorized system can track the capsule when it is detectable and charge the supercapacitor and the supercapacitor supplies the energy for the undetectable situations.
a) The idea can be applied to any kind of freely moving object which needs to be tracked and transferred required power for the implanted or tag device. The potential applications are the animal research in the laboratories, and also remotely powered endoscopic capsule for the human digestion examination.
b) Also this idea can be applied not only for magnetic power transmission but also other kind of energy harvesting and power transfer methods such as ultrasound, light, etc. which have a power source and a movable target (tag, implant). The power source can track the target and deliver the power to charge the storage element.

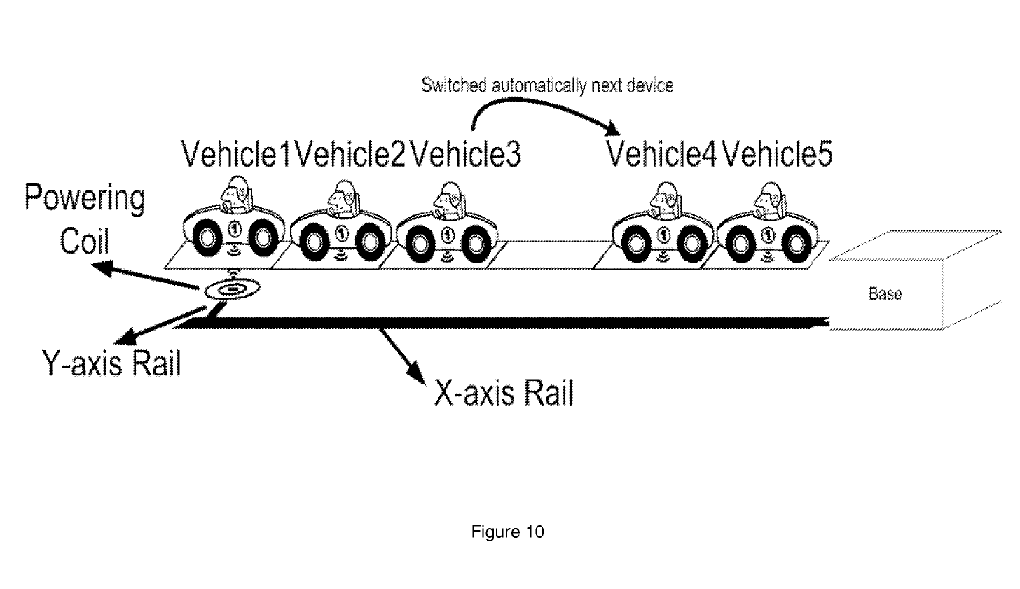

The same motorized system can be also applied for the parking lots. For example, the public transportation bus in the garage can be charged during the night automatically by these systems as shown in FIG. 10.

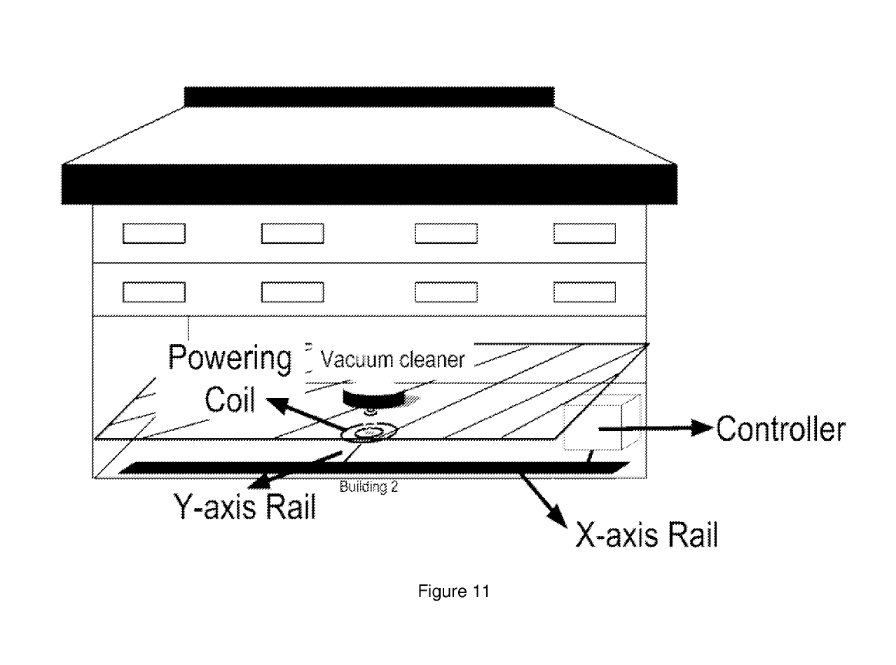

A freely moving magnetic plug (MPlug) can be applied for a smart house. This plug serves a magnetic field for remotely powered devices or remotely chargeable devices. For example, a vacuum cleaner can be activated by MPlug as shown in FIG. 11. In addition, MPlug can be activated and moved by the user also manually to receive power turn on the devices and/or charge the devices.

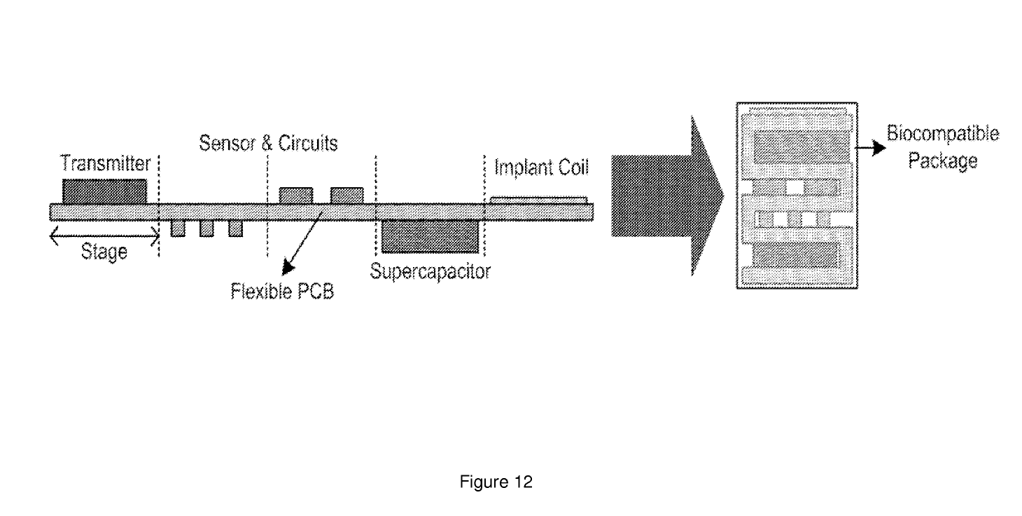

In a preferred embodiment, the implant unit is designed for minimum space consumption. Therefore, a flexible printed circuit board (PCB) is used and the implantable unit is folded in stages to squeeze in a cubic package as shown in FIG. 12. It will be tested in mice and or in rats. It can also be tested in patients.

### REFERENCES

1. D. C. Yates, A. S. Holmes, A. J. Burdett, “Optimal transmission frequency for ultralow-power short-range radio links,” in IEEE Trans. Circuits Syst. I, 2004, vol. 51, no. 7, pp. 1405-1413.

2. Silay K M, Dehollain C, and Declercq M. Inductive power link for a wireless cortical implant with biocompatible packaging. Proceedings of the IEEE Sensors conference, 1 to 4 Nov. 2010, Kona, Hawai (USA), pp. 94-98

3. Silay K M, Dehollain C , Declercq M. Numerical Thermal Analysis of a Wireless Cortical Implant with Two-Body Packaging. BioNanoScience Journal, Springer, June 2011, 11 pages.

4. Pillin N, Joehl N, Dehollain C, and Declercq M. High Data Rate RFID Tag Reader Architecture using Wireless Voltage Regulation. IEEE TCAS1 Journal, March 2010, pp. 714-724

5. Liu X and Dehollain C. A non-linear model for micropower rectifier in UHF-band RFIDs. Proceedings of the IEEE ICECS conference, Athens, Greece, 12 to 15 Dec. 2010, pp. 1057-1060.

6. Mazzilli F, Thoppay P E, Joehl N, Dehollain C. Design Methodology and comparison of rectifiers for UHF-band RFIDs. Proceedings of the 2010 IEEE Radio Frequency Integrated Circuits Symposium (RFIC), Anaheim, USA, 23 to 25 May 2010, pp. 505-508.

7. Mazzilli F, Peisino M, Mitouassiwou R, Cotte B, Thoppay P, Lafon C, Favre P, Meurville E, Dehollain C. In-Vitro Platform to Study Ultrasound as Source for Wireless Energy Transfer and Communication for Implanted Medical Devices. Proc. of the Annual International Conference of the IEEE Engineering in Medicine and Biology Society (EMBC), Buenos Aires, Argentina, 31 Aug. to 4 Sep. 2010, pp. 3751-3754.

8. Cotté B, Lafon C, Chapelon J Y, Dehollain C. Suitable acoustic paths to transfer energy in depth using ultrasound. Proc. of the Annual International Conference of the IEEE Engineering in Medicine and Biology Society (EMBC), Buenos Aires, Argentina, 31 Aug. to 4 Sep. 2010, pp. 6694-6697.

1. Telemetric device with electronics comprising:
(a) at least one of a sensor, an actuator or a data transmission device;
(b) at least one super-capacitor arranged as a power storage and a supply voltage for the at least one of a sensor, an actuator or a data transmission device; and
(b) an intelligent charging electronic circuit configured to charge the super-capacitor to a predetermined voltage level.

2. The telemetric device of claim 1, wherein the intelligent charging electronic circuit comprises a power on reset circuit configured to prevent current from flowing through the intelligent charging electronic circuit when the supply voltage is insufficient for the at least one of a sensor, an actuator or a data transmission device.

3. An implantable device for use in a freely moving object, comprising the telemetric device of claim 1.

4. A system comprising the implantable device of claim 3, further comprising tracking means distinct from the implantable device and configured to track a movement of the implanted device, and
an intelligent remote powering mechanism distinct from the implantable device and arranged to provide power to the super-capacitor, and comprising
a power source; and
actuating means configured to move the power source according to the movement of the implanted device.

5. The system of claim 4, further comprising;
at least one additional implantable device comprising a corresponding additional tracking means, and a corresponding additional intelligent remote powering system.

6. The system according to claim 4, wherein the power source is one of the list comprising a powering coil, an antenna, and a transducer.

7. The system according to claim 4, wherein the intelligent remote powering system is extended for multiple freely moving objects.

8. The system according to claim 4, further comprising one of a rechargeable battery and a supercapacitor, further comprising detection means arranged to detect a proximity of the implanted device and trigger the charge of the implantable device.

9. The system according to claim 8, wherein the implantable device is a remotely powered capsule for biomedical application.
